(19) United States
(12) Patent Application Publication
(10) Pub. No.: US 2014/0324816 A1
(43) Pub. Date: Oct. 30, 2014

(54) EXTENDED WEB SEARCH INFRASTRUCTURE SUPPORTING HOSTING CLIENT DEVICE STATUS

(71) Applicant: Broadcom Corporation, Irvine, CA (US)

(72) Inventors: James Duane Bennett, Hroznetin (CZ); Yasantha Nirmal Rajakarunanayake, San Ramon, CA (US); Wael William Diab, San Francisco, CA (US)

(73) Assignee: Broadcom Corporation, Irvine, CA (US)

(21) Appl. No.: 13/902,731

(22) Filed: May 24, 2013

Related U.S. Application Data
(60) Provisional application No. 61/816,938, filed on Apr. 29, 2013.

(51) Int. Cl. G06F 17/30

(52) U.S. Cl. CPC G06F 17/30867
USPC 707/709; 707/770; 707/722

(57) ABSTRACT

A system and method is provided for internet searching infrastructures and more particularly to hosted client device status supporting the delivery of search results hosted by a client device. A registry table retains client device status information so that when a search result includes specific device hosted content, that client device's status will be known. Client device status includes sleep, offline, predicted period of availability, do-not-disturb (DnD), power availability, or busy along with other status indications.

### CROSS REFERENCE TO RELATED APPLICATIONS

The present U.S. Utility patent application claims priority pursuant to 35 U.S.C. §119(e) to U.S. Provisional Patent Application Ser. No. 61/816,938, entitled “Extended Web Search Infrastructure Supporting Hosting Client Device Status,” filed Apr. 29, 2013, pending, which is hereby incorporated herein by reference in its entirety and made part of the present U.S. Utility patent application for all purposes.

### BACKGROUND

1. Technical Field

The present disclosure described herein relates generally to internet searching infrastructures and more particularly to hosting client device status.

2. Description of Related Art

Current web search engine infrastructures use web crawling of web page hosting servers to identify hosted web pages and media content. Text within each identified web page is pre-processed and added to reverse indexed databases. Media content (e.g. images) is also pre-processed and added to media characteristic databases. Such media content and hosted web pages are also often cached by web search infrastructure.

In addition, currently, a client device uploads content to a web server for hosting so that such server can expose such content to others via web searching. This requires finding a hosting service, engaging an uploading process and otherwise intentionally interacting in a time consuming process. Otherwise, establishing connections from one client device to another for direct retrieval of client content is also often difficult if not impossible for many users.

### BRIEF DESCRIPTION OF THE DRAWINGS

FIG. 1 is a system diagram illustrating a communications environment embodiment in accordance with the present disclosure;

FIG. 2 is an internet search infrastructure diagram illustrating one embodiment in accordance with the present disclosure;

FIG. 3 is an internet search infrastructure diagram illustrating another embodiment in accordance with the present disclosure;

FIG. 4 is a search infrastructure illustrating one embodiment in accordance with the present disclosure;

FIG. 5 illustrates a search infrastructure flow diagram showing one embodiment in accordance with the present disclosure;

FIG. 6 illustrates a client device showing one example embodiment in accordance with the present disclosure;

FIG. 7 illustrates a client device showing another example embodiment in accordance with the present disclosure;

FIG. 8 illustrates a search infrastructure flow diagram showing one embodiment in accordance with the present disclosure; and

FIG. 9 illustrates a client device embodiment for powering down the device in accordance with the present disclosure.

### DETAILED DESCRIPTION

In one or more embodiments of the technology described herein, a system and method is provided to support the delivery of search results with a client device's status. The client device's status includes, for example, sleep, offline, predicted period of availability (i.e., available at 10 pm, available after 9 am), do-not-disturb (DnD), power availability, “please wait”, “available soon” or busy along with other status indications.

In one embodiment, client devices directly host web content via web search infrastructure support. In various example embodiments, personal devices (including tablets, smartphones, laptops, STB's and other home entertainment devices, AP's, home NAS, etc.) become part of an overall web search storage infrastructure. Also, search index data and other search data are extracted via pre-processing of client content to support web searching spanning both traditional server hosted content but also device hosted content. In other words, this will involve often roaming client devices participating in content hosting. Such client content comprises, for example, media, data, programs/apps, services, files, etc., and in some embodiments extends to client hosted web page data as well.

Search databases will point (User device IP addressing and log in ID's) to particular content stored at the client devices. Search results will identify web hosting server content (traditional approach) plus client hosted content in combined or separately tabbed or filtered formats. To support servicing search requests, the search infrastructure processes received and stored hosted content to extract indexed database data to be added to its search database infrastructure of reverse text indexes, associated hypertext linkages, associated IP addresses, media characteristic data, etc.

In one embodiment, in addition to storing search database data relating to client device content, the content itself is stored and hosted. Because client devices are often unreliable in providing adequate and uninterrupted hosting services, the search infrastructure stands in to support same via caching or full backup support. Client devices, in one or more embodiments, contract for such services and pay in a manner not much different from that associated with web server hosting. For example, in one embodiment, a client device chooses to pay, upload while never having tied to hosting services as the search infrastructure will handle it for them.

In one or more embodiments, another client device (or the same device but in relationship to other client data/services) chooses to handle the hosting itself (i.e., as in described above) or a third client device chooses to handle whatever it can but have the search infrastructure step in to provide hosting services when the third client device is fully engaged.

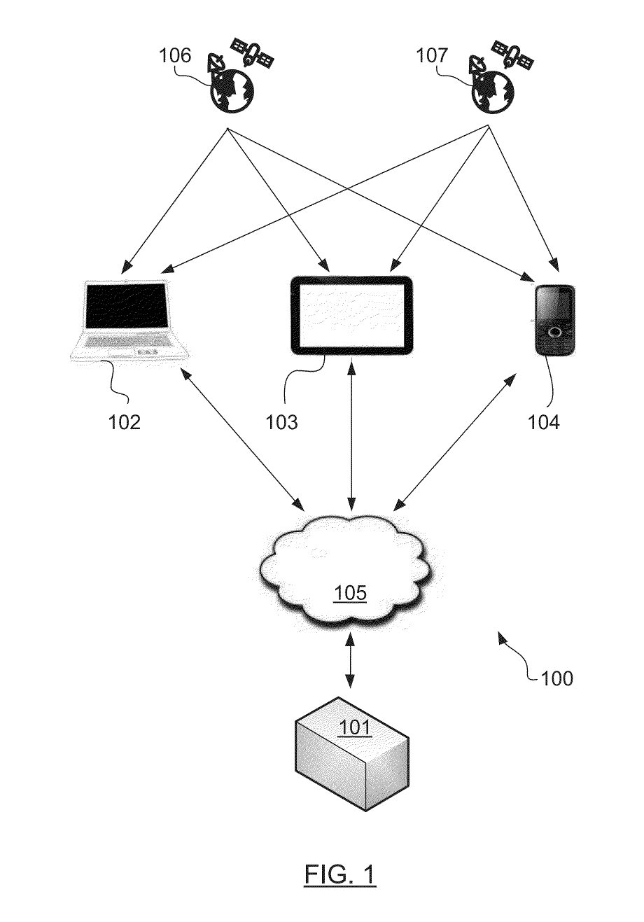

FIG. 1 is a system diagram illustrating an embodiment of a communications environment in accordance with the present disclosure. System 100 includes search system 101 connected to a plurality of mobile communication devices, for example, laptop 102, tablet 103 and smartphone 104, connected via network 105 and in geographically distinct locations. Network 105 may include any known or future communications network, structure and/or standard such as, but not limited to, 3G (Third Generation), 4G (Fourth Generation), LTE (Long-term Evolution), GSM (Global System for Mobile Communications), Wi-Fi, WiMax, WLAN (wireless area network), a WAN (wide area network), a LAN (local area network) and MIMO (Multiple Input Multiple Outputs).

In one embodiment, laptop 102 is used to originate content (e.g., images, video, audio, programming source code, text, database data, etc. in any one of a plurality of file format types). Offloading search system's 101 support responsibilities, laptop 102, in one or more embodiments, preprocesses its originated content to generate at least one search format output that can be uploaded and consumed by search system 101 into its underlying search database infrastructure. After receiving and integrating such search format output, search system 101 receives a search input from tablet 103 that targets the content currently stored on laptop 102. Search system 101 uses the search input in searching database data to identify such content in search results. Thereafter, tablet 103 may interact via the search results and laptop 102 to gain access to the stored content. Instead of, or in addition to, local storage for future search servicing, the originated content itself may be uploaded (along with the preprocessed search format output) for storage within search system 101 to support content delivery from search system 101 to tablet 103 based on search result interaction. Laptop 102 may also further supplement such upload with status information, payment requirements, searcher restrictions, DRM (digital rights management) requirements, loading information, hosting characteristics, scheduling information, etc.

In one or more embodiments, the mobile communication devices are in communication with GPS satellites 106 and 107, and/or terrestrial based location providing services to provide the mobile communication devices with location information. In alternative embodiments, location information for the mobile communication devices is obtained using other information such as media access control (MAC) address, internet protocol (IP) address, or equivalents known or future.

While mobile communication devices 102 to 104 illustrated as laptop 102, tablet 103 and smartphone 104, they are interchangeable with any mobile communications device such as: a cellular telephone, a local area network device, personal area network device or other wireless network device, a personal digital assistant, personal computer, laptop computer, wearable computers, tablet computers or other devices that perform one or more functions that include communication of voice and/or data via a wireline connection and/or the wireless communication path. In yet other embodiments, mobile communication devices 102 to 104 are an access point, base station or other network access device that is coupled to network 105 such as the Internet or other wide area network, either public or private, via a wireline or wireless connection.

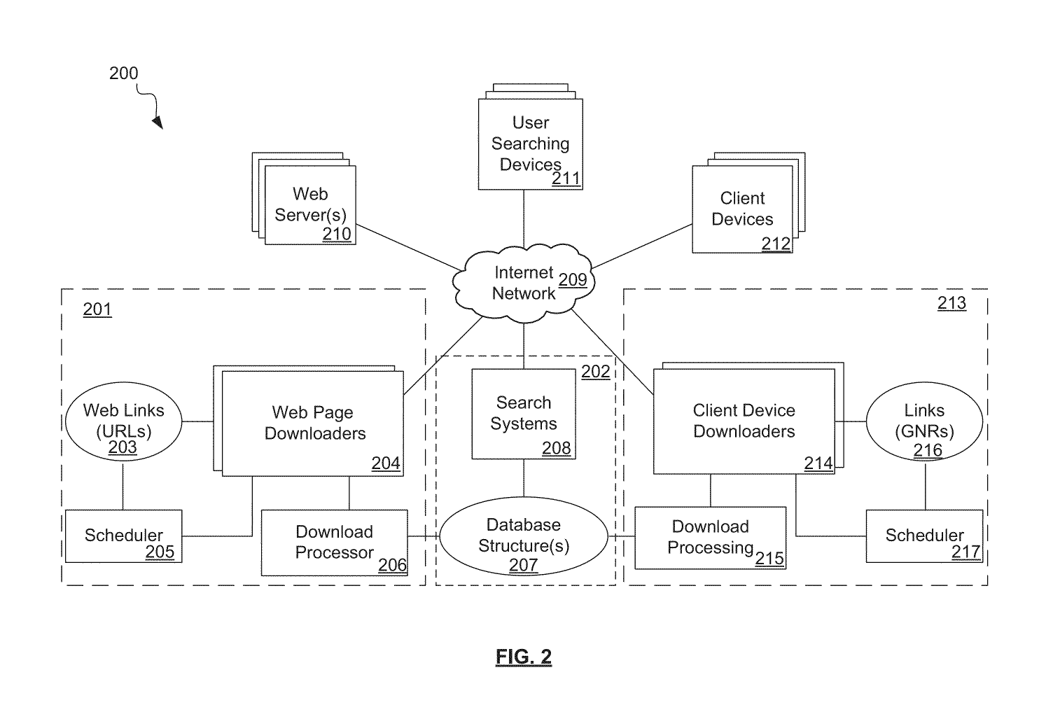

FIG. 2 is an internet search infrastructure diagram illustrating one embodiment in accordance with the present disclosure. Internet search infrastructure 200 includes search system infrastructure components web crawler 201, client device crawler 213 and search engine infrastructure 202. Web crawler 201 includes one or more processing modules 203-206 which systematically browse the World Wide Web (WWW), typically for the purpose of building a database of web based content. Web crawler 201 uses a list of web links (pointers) supplied by link module 203 such as uniform resource locators (URLs) to visit. The URLs are called seeds as they start a process of content discovery and typically are provided by domain registrations. As the crawler visits these URLs, one or more web page downloader module(s) 204 parse the URLs to identify unique hyperlinks in the page, which point to web server 210 to stored content. URLs are typically recursively visited according to a set of policies, which detect structure and content. As links are traversed, web pages and specific content are downloaded by web page downloader module(s) 204 as per a schedule dictated by scheduler module 205.

Web page downloader module(s) 204 will interact with each web server to manage content related uploads into the search infrastructure 200. A first group of web servers 210 will act in conventional ways by providing content in native formats (html, xml, jpg, mp3, pdf, etc.) without preprocessing of the content. In addition to providing such content uploads, a second group of web servers 210 will also upload associated preprocessing output, i.e., at least one search format output that is more easily consumed into the search database structure 207 of the search engine infrastructure 202. A third group of web servers will provide such preprocessing output uploads, but without content uploading.

In one embodiment, web page downloader module(s) 204 further include preprocessing of webpages. Preprocessing, typically performed by web server(s) 210, includes extracting, in one embodiment, non-text information about images. This information includes, for example, whether the image is black and white, a sketch, drawing file, full color, a photograph, clip art, facial recognition, age/sex id (i.e., adult, child, senior, male, female, etc.). In addition, in one embodiment, access information is extracted such as public, private, sharing lists, grouping, download and distribution rights, security, or access based on income, gender, age, location, citizenship, relationships, membership, etc.

Download processor module 206 reverse indexes a selected web page to encode web page words (e.g., frequency) while noting a location on the associated page (offset) so that content can be recovered (extracted) at a later time. The indexed data is stored in memory of database structure 207 (search database) where it is stored for later access by search engine(s) 208. In addition to web page words, all Multipurpose Internet Mail Extensions (MIME) (file types and formats) can be preprocessed by dedicated processing elements so as to produce something that can easily be integrated into a search database structure to support searching. Other examples include, but are not limited to, .mp3 files being analyzed to identify pop, jazz, or other music type, versus child, animal, adult female voices, etc. Image analysis and categorization such as line drawing, sketch, black and white, painting scan, watercolor, content identity: face, architecture, landscape, group of humans, object identification, face identification (actual name determination), etc.; program code language, underlying functions, operating environments, programmers, updates, version, copyright, etc., as determined from the code file and file format; text within any content file format (such as reverse indexing word and pdf files or via OCR's (optical character recognition) associated with scanned text or image text. Common database needs to (reverse) index parameters and text into a common structured format, while breaking down the obligation to search and process across each MIME types repeatedly. While such preprocessing could take place centrally, offloading at least a portion of the preprocessing duties to either clients or both of the web servers reduces workload requirements for any of the devices.

In one or more embodiments, database structure 207 includes indexes of unique words with associated index pointers (URLs) and web page position information. Unique words are hashed using a hash table. A hash table (also hash map) is a data structure used to implement an associative array, a structure that can map keys to values. A hash table uses a hash function to compute an index into an array of buckets or slots, from which the correct value can be found. Unique words are typically arranged by frequency (e.g., highest to lowest) and also carry importance using frequency ranking. For example, in the phrase “the cat”, the word “the” is not important and the word “cat” is important. Rare words are often given highest importance along with strings of words and rare strings of words.

Internet Network 209 is a global system of interconnected computer networks that use the standard Internet protocol suite (TCP/IP) to serve billions of users worldwide. It is a network of networks that consists of millions of private, public, academic, business, and government networks, of local to global scope, that are linked by a broad array of electronic, wireless and optical networking technologies. The Internet carries an extensive range of information resources and services, such as the inter-linked hypertext documents of the World Wide Web (WWW) and the infrastructure to support email. The internet network is used to interconnect the various elements of system 200 and is implemented using known and future communication infrastructures such as wireless and wired networks including, but not limited to, wireless local area networks (WLANs), wide area networks (WANs), local area networks (LANs), Ethernet, fiber optic or other known or future communication network infrastructures. Internet Network 209 interconnects web servers 210, user searching devices 211 and client devices 212, to the search system infrastructure (201, 202 and 213) which use the indexed data to match a user input search string from user search device 211 (e.g., smartphone, tablet, laptop, desktop or other known or future user devices with communications capabilities).

The internet search infrastructure of FIG. 2 is, in one or more embodiments described herein, also in communication with one or more GPS satellites and/or terrestrial geographic location systems (FIG. 1 elements 106 and 107) that provide the one or more communication devices with location information. In alternative embodiments, location information for one or more communication devices is obtained using other information such as a media access control (MAC) address, an internet protocol (IP) address, or the like.

In one or embodiments of the technology described herein, internet search infrastructure 200 includes client device generated and/or hosted data. Client device generated data includes creation of content by users of client devices 212 (e.g., mobile communication devices 102 to 104). Once new content is created by the user of client device 212, the data is stored locally (e.g., in memory on the client device 212 with an associated pointer to the content) or remotely (e.g., within the search system infrastructure and/or in the cloud including, for example, third party servers with a modified pointer). Created client device content includes, in one embodiment, downloaded content and/or aggregated content on the client device.

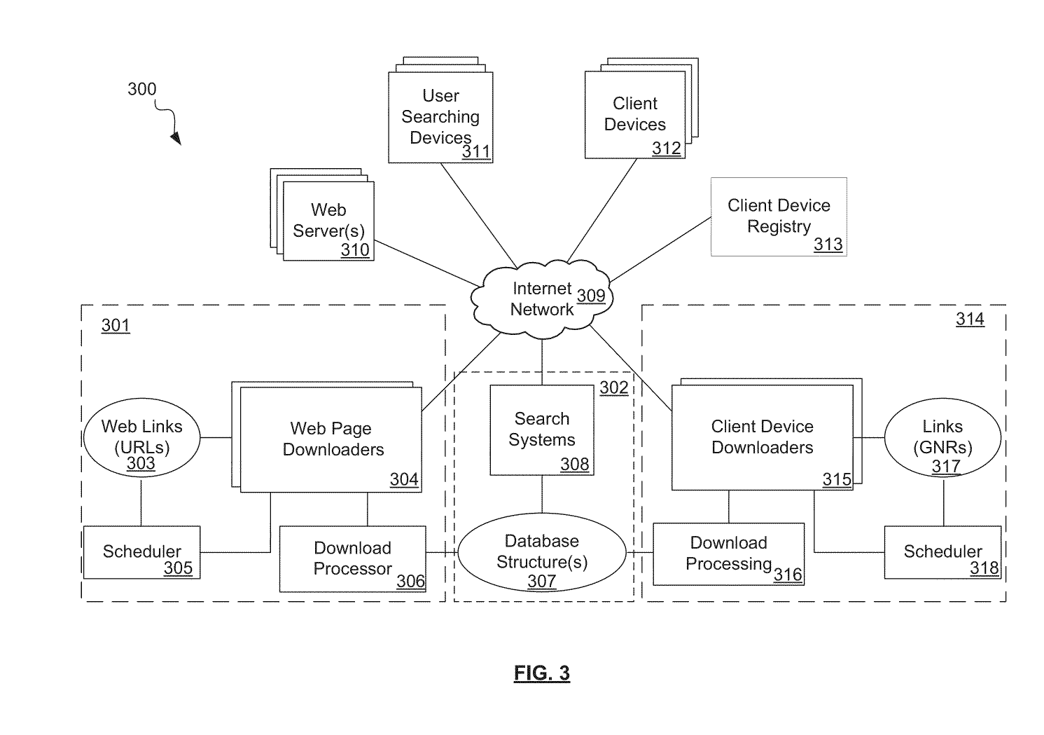

Content hosted by client device 212 (client device content) is supported within the search system infrastructure by client device content crawler 213 which mirrors the web crawling elements 201. While shown as separate crawlers, web and client device crawling functions can, in one embodiment, be combined into a single crawler system providing crawling for both web and client hosted content. Client device content crawling system 213 accesses and parses content(data) stored in memory (shown in FIG. 3, element 305) on one or more client devices 212 in much the same way a traditional web crawler would crawl a web page located on a web server. The client device content crawler 213 includes, but is not limited to, one or more client device downloader modules 214 which access and process (e.g., parse) the content hosted by the client device in a similar fashion to web pages for downloader module 204. Client device downloader module(s) 214 can, in one or more embodiments, receive a link/pointer (such as a global network route) which is a unique path to client device content and/or associated content) from link module 216, download the content itself directly from the client device or a download a copy of the client device hosted content from a client device designated storage location external to the client device. In addition, access data (e.g., client device identification, client type, and client status) is made available to the downloader modules to provide access to the content/associated content (e.g., preprocessed content). In one embodiment, the client device provides the pointer and access data to a client device registry 218, for example a registry maintained in memory within a cloud based service which is accessible by the search system infrastructure (downloader module). The client device content crawling system 213 further includes scheduler module 217 to schedule the crawling of the client device created/stored content and download processor module 215 to reverse index the client device hosted content and distribute to database structure 207 which is accessible by search engine(s) 208 and user searching devices 211.

User searching devices 211 include, but are not limited to: mobile phones; smartphones; tablets; laptops; desktops; or other known or future user computing devices with communications capabilities. In one or more embodiments disclosed herein, mobile communication devices are the recipients of the preprocessed, indexed and stored search system infrastructure output. These mobile communication devices are, in one or more embodiments, a mobile phone such as a cellular telephone, smartphone, a local area network device, a personal area network device or other wireless network device, a personal digital assistant, a personal computer, a laptop computer, wearable computers (e.g., heads-up display (HUD) glasses), tablet computers or other devices that perform one or more functions that include communication of voice and/or data via a wireline connection and/or the wireless communication path. Additionally, in one or more embodiments, mobile communication devices are an access point, base station or other network access device that is coupled to a network such as the Internet or other wide area network, either public or private, via a wireline/wireless connection. Please note, while shown as separate devices for functional clarity, user searching devices can also be client devices and vice-versa (e.g., using smartphones or tablets).

FIG. 3 is an internet search infrastructure diagram illustrating one embodiment in accordance with the present disclosure. Internet search infrastructure 300 includes search system infrastructure components web crawler 301, client device crawler 314 and search engine infrastructure 302 (typically operated by a search service). Web crawler 301 includes one or more processing modules 303-306 which systematically browse the World Wide Web (WWW), typically for the purpose of building a database of web based content. Web crawler 301 uses a list of web links (pointers) supplied by link module 303 such as uniform resource locators (URLs) to visit. The URLs are called seeds as they start a process of content discovery and typically are provided by domain registrations. As the crawler visits these URLs, one or more web page downloader module(s) 304 parse the URLs to identify unique hyperlinks in the page, which point to web server 310 to stored content. URLs are typically recursively visited according to a set of policies, which detect structure and content. As links are traversed, web pages and specific content are downloaded by web page downloader module(s) 304 as per a schedule dictated by scheduler module 305.

Web page downloader module(s) 304, in one embodiment, further include preprocessing of webpages. Preprocessing, typically performed by web server(s) 310, includes extracting, in one embodiment, non-text information about images. This information includes, for example, whether the image is black and white, a sketch, drawing file, full color, a photograph, clip art, facial recognition, age/sex id (i.e., adult, child, senior, male, female, etc.). In addition, in one embodiment, access information is extracted such as public, private, sharing lists, grouping, download and distribution rights, security, or access based on income, gender, age, location, citizenship, relationships, membership, etc.

Download processor module 306 reverse indexes a selected web page to encode web page words (e.g., frequency) and note location on the associated page (offset) so that content can be recovered (extracted) at a later time. The indexed data is stored in memory of database structure 307 (search database) where it is stored for later access by search engine(s) 308.

In one or more embodiments, database structure 307 includes indexes of unique words with associated index pointers (URLs) and web page position information. Unique words are hashed using a hash table. A hash table (also hash map) is a data structure used to implement an associative array, a structure that can map keys to values. A hash table uses a hash function to compute an index into an array of buckets or slots, from which the correct value can be found. Unique words are typically arranged by frequency (e.g., highest to lowest) and also carry importance using frequency ranking. For example, in the phrase “the cat”, the word “the” is not important and the word “cat” is important. Rare words are often given highest importance along with strings of words and rare strings of words.

Internet Network 309 is a global system of interconnected computer networks that use the standard Internet protocol suite (TCP/IP) to serve billions of users worldwide. It is a network of networks that consists of millions of private, public, academic, business, and government networks, of local to global scope, that are linked by a broad array of electronic, wireless and optical networking technologies. The Internet carries an extensive range of information resources and services, such as the inter-linked hypertext documents of the World Wide Web (WWW) and the infrastructure to support email. The internet network is used to interconnect the various elements of system 300 and is implemented using known and future communication infrastructures such as wireless and wired networks including, but not limited to, wireless local area networks (WLANs), wide area networks (WANs), local area networks (LANs), Ethernet, fiber optic or other known or future communication network infrastructures. Internet Network 309 interconnects web servers 310, user searching devices 311 and client devices 312, to the search system infrastructure (301, 302 and 314) which use the indexed data to match a user input search string from user search devices 311 (e.g., smartphone, tablet, laptop, desktop or other known or future user devices with communications capabilities).

The internet search infrastructure of FIG. 3 is, in one or more embodiments described herein, also in communication with one or more GPS satellites and/or terrestrial geographic location systems (FIG. 1 elements 106 and 107) that provide the one or more communication devices with location information. In alternative embodiments, location information for one or more communication devices is obtained using other information such as a media access control (MAC) address, an internet protocol (IP) address, or the like.

In one or embodiments of the technology described herein, internet search infrastructure 300 includes client device generated and/or hosted data. Client device generated data includes creation of content by users of client devices 312 (e.g., mobile communication devices 102 to 104). Once new content is created by a user of one of the client devices 312, the data is stored locally (e.g., in memory on the client device 312 with an associated pointer to the content) or remotely (e.g., within the search system infrastructure and/or in the cloud including, for example, third party servers with a modified pointer). Created client device content includes, in one embodiment, downloaded content and/or aggregated content on the client device.

Content hosted by client devices 312 (client device content) is supported within the search system infrastructure by client device content crawler 314 which mirrors the web crawling elements 301. While shown as separate crawlers, web and client device crawling functions can, in one embodiment, be combined into a single crawler system providing crawling for both web and client hosted content. Client device content crawler 314 accesses and parses content (data) stored in memory on one or more client devices 312 in much the same way a traditional web crawler would crawl a web page located on a web server. The client device content crawler 314 includes, but is not limited to, one or more client device downloader modules 315 which access and process (e.g., parse) the content hosted by the client device in a similar fashion to web pages for downloader module 304. Client device downloader module(s) 315 can, in one or more embodiments, receive a link/pointer (such as a global network route) which is a unique path to client device content and/or associated content) from link module 317, download the content itself directly from the client device or a download a copy of the client device hosted content from a client device designated storage location external to the client device. In addition, access data (e.g., client device identification, client type, and client status) is made available to the downloader modules to provide access to the content/associated content (e.g., preprocessed content). In one embodiment, the client device transmits the pointer and access data to a client device registry 313, for example a registry maintained in memory within a cloud based service which is accessible by the search system infrastructure (downloader module). The client device content crawling system 314 further includes scheduler module 318 to schedule the crawling of the client device created/stored content and download processor module 316 to reverse index the client device hosted content and distribute to database structure 307 which is accessible by search engine(s) 308 and user searching devices 311.

User searching devices 311 include, but are not limited to: mobile phones; smartphones; tablets; laptops; desktops; or other known or future user computing devices with communications capabilities. In one or more embodiments disclosed herein, mobile communication devices are the recipients of the preprocessed, indexed and stored search system infrastructure output. These mobile communication devices are, in one or more embodiments, a mobile phone such as a cellular telephone, smartphone, a local area network device, a personal area network device or other wireless network device, a personal digital assistant, a personal computer, a laptop computer, wearable computers (e.g., heads-up display (HUD) glasses), tablet computers or other devices that perform one or more functions that include communication of voice and/or data via a wireline connection and/or the wireless communication path. Additionally, in one or more embodiments, mobile communication devices are an access point, base station or other network access device that is coupled to a network such as the Internet or other wide area network, either public or private, via a wireline/wireless connection. Please note, while shown as separate devices for functional clarity, user searching devices can also be client devices and vice-versa (e.g., using smartphones or tablets).

In one embodiment, client device status information is transmitted from the individual client devices to client device registry 313. Each client device is identified by its client device identification (ID) and, when transmitted, the status information corresponding to the client device ID is recorded. In another embodiment, transmitted client device status information replaces the previous client device status information to ensure that the information is current. In accordance with yet another embodiment, the client device search information is transmitted to search in real time. Status information for client device 212 includes, for example, sleep, offline, predicted period of availability, do-not-disturb (DnD), power availability, or busy along with other status indications.

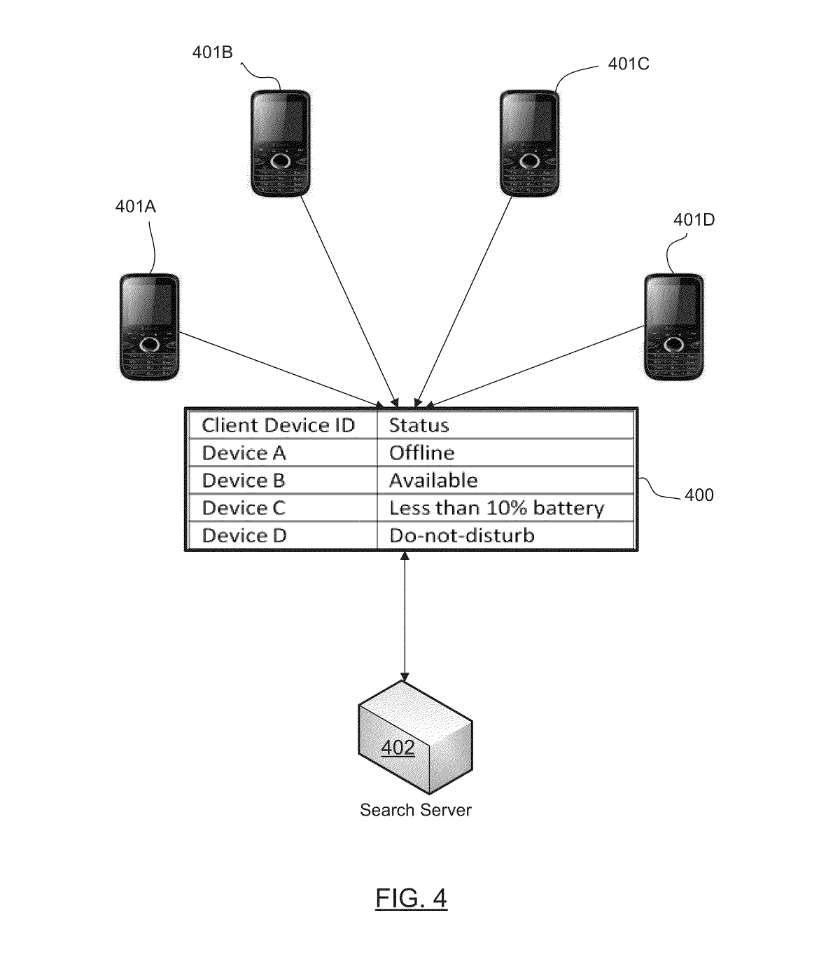

FIG. 4 is a search infrastructure illustrating one embodiment in accordance with the present disclosure. Client devices 401A, 401B, 401C and 401D are in communication with client device status table 400. Client device status table 400 is an example table as stored within memory of client device registry 313. In one embodiment, client devices 401A to 401D periodically transmit individual device status information to the client device registry where the status information is stored in the client device status table 400 on a periodic schedule. For example, client device 401A transmits a status update to client device ID status every second. In alternative embodiments, client devices 401A through 401D transmit status information to update client device status table 402 upon request from either the client device registry, search infrastructure and/or a searching device. In yet another embodiment, a client device transmits status information to update client device status table 402 upon a change in status. For example, client device 401A has been offline but when it becomes available again, client device 301A transmits a new status update to update client device status table 402.

In an example embodiment, client device status table 402 is part of network storage (e.g., on a server farm such as cloud storage). As previously discussed, the client devices status table forms part of a network registry of client device's status. Client device status is pushed (from the client device to the registry), pulled (by the registry) or a combination of push/pull. The registry in one or more embodiments is held in third party storage, part of the search infrastructure or held locally on one or more devices (fixed or mobile). In one embodiment, the client device status is retrieved by the search infrastructure by transmitting a request for status information to the registry using a client device unique identification. In alternative embodiments, the client device status table 400 is part of a client device registry within another network in communication with a search infrastructure. In yet another embodiment, the default client device status is offline until a transmission is received from the client device having a different status.

In one or more embodiments, status information from a client device is device specific, content specific, service specific or any combination thereof. For example, a client device's specific status information based on the manufacture details is provided with the search results. For example, the manufacture details of a client device such as brand and model information are provided. In alternative embodiments, a client device's specific status information is based on the type of client device. For example, a search requester will only want searchable content from a specific type of device (e.g., smartphones). Client devices include, but are not limited to: mobile phones; smartphones; tablets; laptops; desktops; or other known or future user computing devices with communications capabilities. These client devices are, in one embodiment, a local area network device, a personal area network device or other wireless network device, a personal digital assistant, a personal computer, wearable computers (e.g., heads-up display (HUD) glasses) or other devices that perform one or more functions that include communication of voice and/or data via a wireline connection and/or the wireless communication path. Additionally, in one or more embodiments, client devices are an access point, base station or other network access device that is coupled to a network such as the Internet or other wide area network, either public or private, via a wireline/wireless connection.

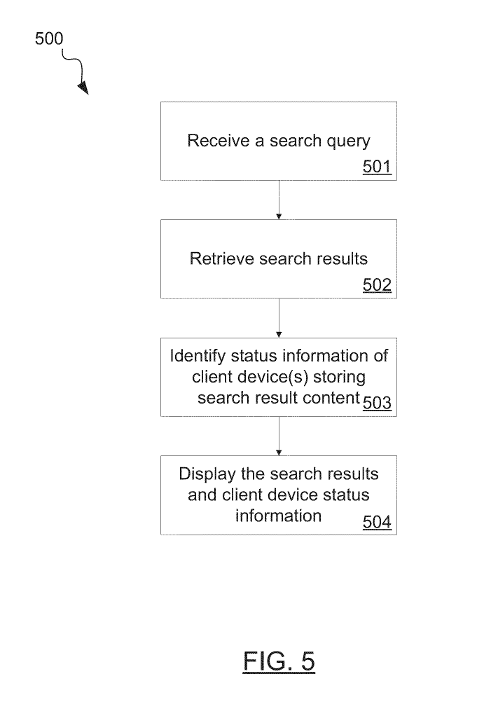

FIG. 5 illustrates a search infrastructure flow diagram showing one embodiment in accordance with the present disclosure. Process 500 begins with step 501 when a search query is received from a searching device requesting search results on a particular subject. In one embodiment, the search query is entered in the searching device by a user using a search query interface. Search inputs include, for example, images, text, audio, video or a combination thereof. Other methods of entering in a search query are also anticipated by the technology described herein such as voice-to-text input or other voice controlled applications. In step 502, search results according to the entered search query are retrieved from the search infrastructure (using one or more search engines). Client devices hosting content corresponding to the search results are identified and status information for each client device is retrieved in step 503. The search results are displayed on the searching device in step 504 along with the client device status information that corresponds to each search result.

In one embodiment, status information is provided based on specific content. Content specific status information provides the status of the client device based on content of the search result. In one embodiment, a list of search results provided for a search query includes various types of content such as photographs, music, audio, video, text or any combination thereof. A user, for example, only wants to receive client device status information from search results of video content that correspond to the search query. In other embodiments, a user selects more than one type of content for receiving status information from corresponding client devices. In alternative embodiments, the status information from client devices is provided based on content subject. For example, status information can be limited to only those search query results pertaining subjects such as sports, politics, history, science, technology, other indexed subjects and equivalents or any combination thereof.

The technology described herein includes providing service specific status information. Service specific status information allows the searching device to control the retrieval of status information based on, for example, cellular service providers, network specific details (i.e., 3G, 4G, LTE, etc.) or any combination thereof. In one embodiment, a searching device receives status information on search results from a client device on an LTE network. The status information for the non-LTE network results is not included in the search results. In one embodiment, the searching device selects to receive status information on search results based on a client device's cellular network.

In another embodiment, the search results are filtered based on the status information. A user interface is provided on the searching device for entering query details. The user interface also provides a list of filters for controlling the query result set based on device status information. For example, a user enters a search query and selects “greater than 50% battery power” from a list of status options. A list of search results is provided to the searching device with each search result corresponding to a client device which has greater than 50% battery power. Other selections include, for example, modes of operation such as sleep mode, busy mode, do-not-disturb (DnD), and availability information such as offline or a predicted period of availability.

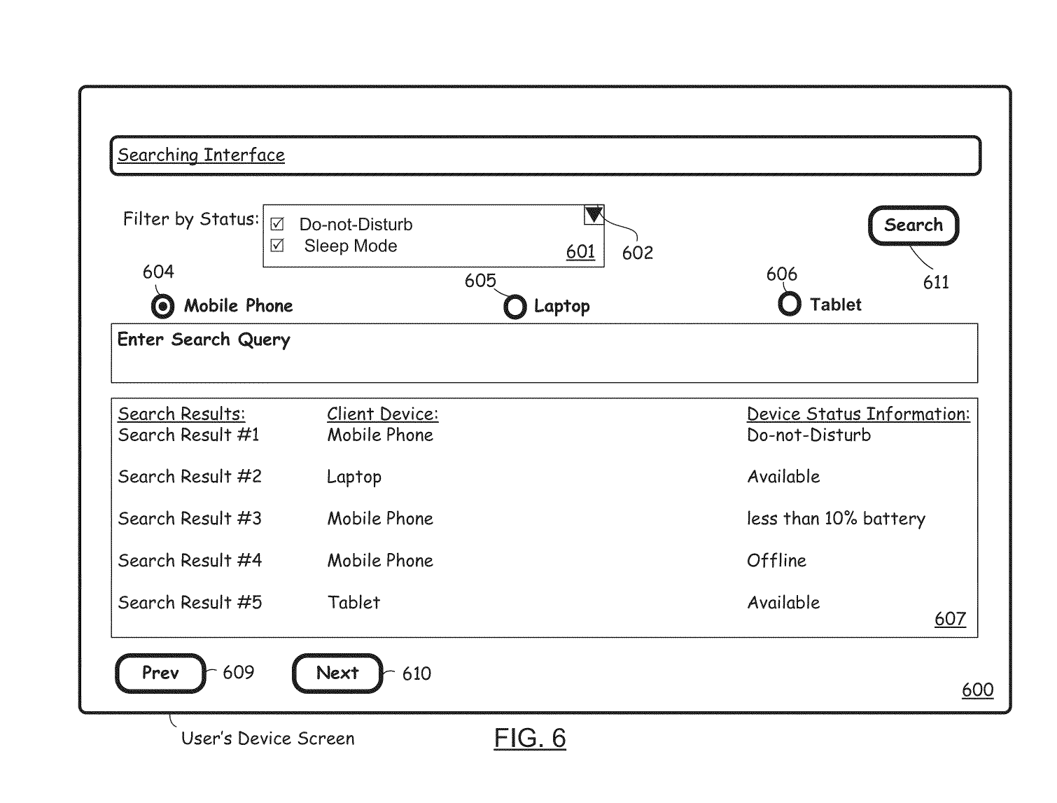

FIG. 6 illustrates a client device showing one example embodiment in accordance with the present disclosure. An interface is provided for executing a search query on a searching device and receiving search results hosted by one or more client devices with their associated client device status information. User Interface (UI) 600 includes selection box 601 for filtering information by client device status. Selection box 601 is shown with two selections of status: do-not-disturb and sleep mode. In other embodiments, the selection box includes, for example, modes of operation such as sleep mode and busy mode and availability information such as offline or a predicted period of availability as well as other equivalents. Selection box 601 includes drop-down arrow 602 for viewing a list of possible status information. Selection checkboxes are shown adjacent to each status; however, other modes of selections are anticipated such as highlighting, drag-and-drop, or other functional equivalents. While shown for selecting from a list, other forms for selecting a filter are within the scope of the technology described herein, such as a text box for typing in status information that is not listed in the provided selections.

User Interface 600 also provides for selections to enable the searching 611 and display of status information from search results of client device specific, client device content specific, client device service specific or any combination thereof. Buttons 604, 605 and 606 allow the searching device to receive client device specific status information from client devices. As shown in the example embodiment illustrated by FIG. 6, mobile phone button 604 is active. Laptop button 605 and tablet button 606 are deselected but multiple selections are possible. By activating mobile phone button 604, only search results from mobile phone client devices and associated status information. For illustration purposes, UI 600 is shown with buttons, but the technology is not limited to a specific type of selection method. Other forms of selection are within the scope of the technology such as a selection menu with a drop-down list, entering text into a text field (i.e., command line language), drag-and-drop, or other equivalent selection methods.

Search results are provided in results screen 607 having a column for search result description (typically a title, abbreviated summary, and link to content), a column for identifying the client device (if content is hosted by a client device) and a column for providing the client device status information. Previous button 609 and next button 610 provide for page navigation through the pages of search results, although other conventional webpage navigation tools are also anticipated and within the scope of the technology described herein. Please note, that for illustration purposes, only client device results are shown. However, it is envisioned that a mixed result of web page results will be listed together with located content hosted on or on behalf of client devices.

While the figures include various screen shots to provide various settings and selections, it is understood that the technology described herein is not limited by these specific construction techniques, settings and selections. Functionally equivalent, known and future constructs, settings and constraints are interchangeable without departing from the scope of the technology described herein. In one example embodiment, status information construction looks similar to web site search tools. In other words, the client device status information piggy backs on regular web search tools or functional equivalents and are consumed by typical web browsers.

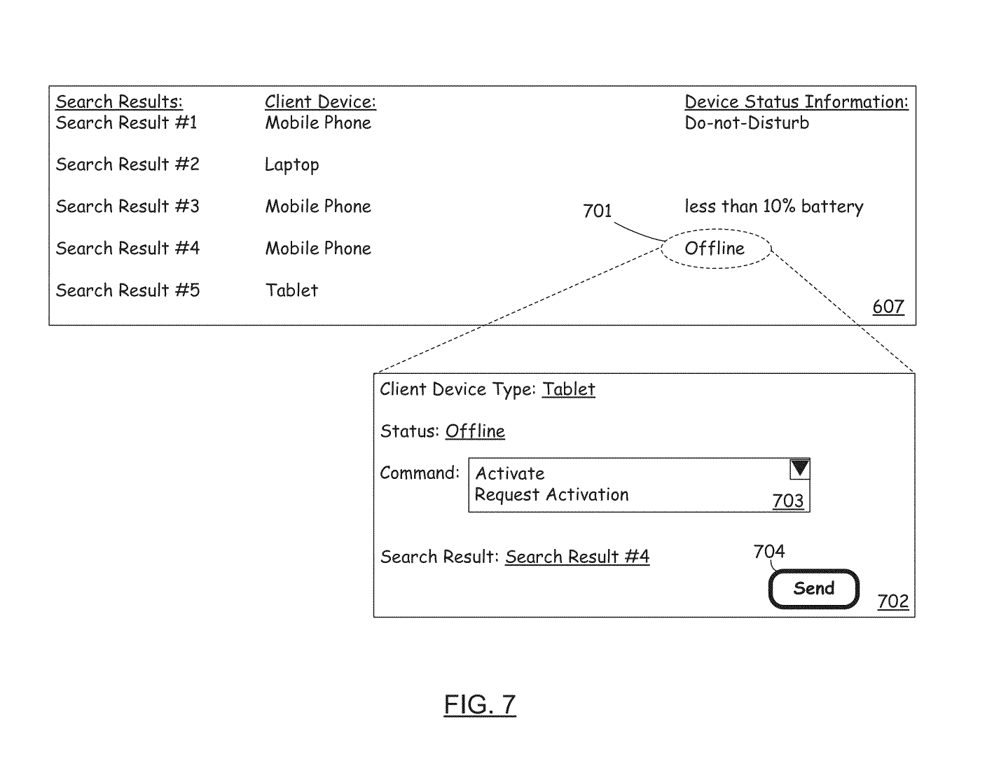

FIG. 7 illustrates a client device showing another example embodiment in accordance with the present disclosure. An interface (e.g., browser) is provided on the searching device where the searching device sends commands to change the status of a client device. Search results 607 are provided from a search query along with the client device type and client device status information of the client devices responsible for the search results. In order to retrieve a result from a client device host it is necessary for the client device to be accessible. If the client device is listed with the status information of “offline” (as shown), the user of the searching device clicks on the current device status information 701 prompting command interface 702. Command interface 702 provides client device details including one or more of client device type, client device status information as well as the search result information from the search results interface. In addition, command interface 702 provides menu 703 for selecting from a drop-down menu the command for the client device. By selecting the “activate” option from the list of commands and clicking send button 704, the searching device sends a command to the offline client device to activate (power on), or become accessible so that the information can become available to the searching device. In another embodiment, the search infrastructure sends a command to change the status of a client device. In an alternative embodiment, the command is sent to the client device as a request requiring confirmation of the request prior to executing the command. For example, if the status of a client device is “offline” and a searching device provides a command to bring the client device online and make it available, the client device would request confirmation from the user of the client device prior to executing the command from the searching device. Commands include, for example, permission to access client device, bring the client device online from the current offline status and other equivalent commands.

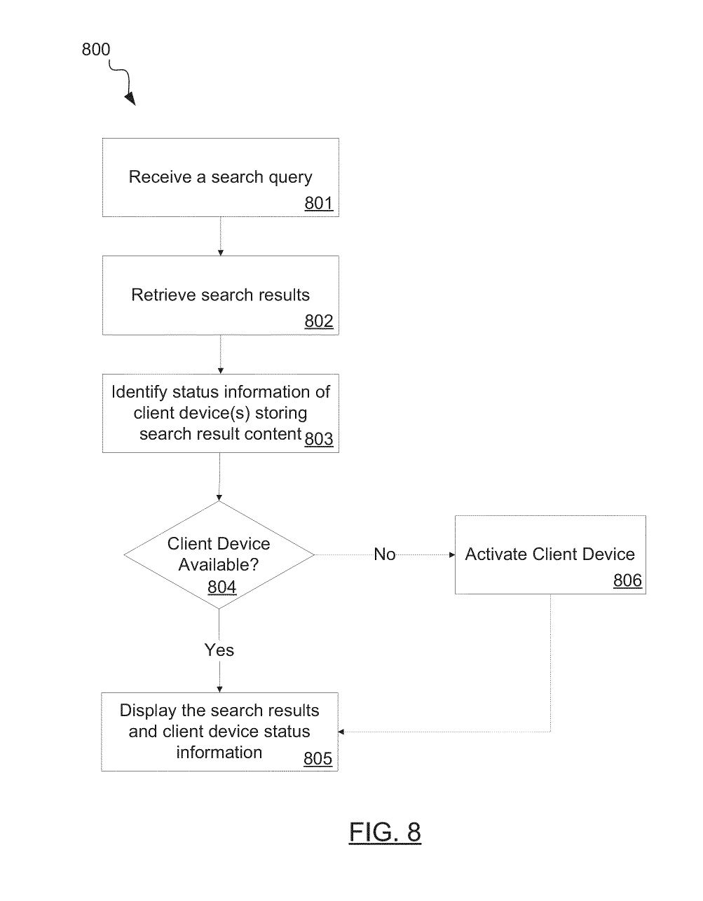

FIG. 8 illustrates a search infrastructure flow diagram showing one embodiment in accordance with the present disclosure. Process 800 begins with step 801 when a search query is received from a searching device requesting search results on a particular topic. In one embodiment, the search query is entered in the searching device by a user using a search query interface. Search inputs include, for example, images, text, audio or a combination thereof. Other methods of entering in a search query are also anticipated by the technology described herein such as voice-to-text input or voice controlled applications. In step 802, the search results according to the entered search query are retrieved from the search infrastructure. Client devices corresponding to the search results are identified and status information for each device is retrieved in step 803. In one embodiment, if the client device has an available status in step 804, the search results are displayed in step 805. Alternatively, if the client device's status is unavailable or the client device is offline, the client device is activated. In step 806, the client device is pinged for activation. In one embodiment, a data packet is transmitted from the search infrastructure to the client device as a request for activation. The client device is activated upon confirmation of the activation request. In another embodiment, the request for activation is provided in a data packet transmitted from a wireless telecommunications network. In yet another embodiment, the request for activation is provided in a data packet transmitted from a registry.

In one embodiment, client device status information is pushed to one or more searching devices upon a change in client device status. In alternative embodiments, the client device status is pushed to one or more searching devices upon login to search infrastructure. For example, a search query is conducted from a searching device where search results are provided including search results from client devices that are listed as “offline”. If one of the client devices with a status listed as “offline” becomes available, the new status information is pushed to the searching device search query results. In one embodiment, the pushed client device's new status information includes delivery of current IP address for the client device. In yet another embodiment, client devices status information is queried upon receiving a possible search hit. For example, a searching device is configured to receive search results from a search query without listing the status information from client devices. Client device status information for a particular search result is made available to the searching device by triggering a status request from the client device responsible for that result. In one embodiment, the triggering of a status request from a client device occurs automatically upon the selection of the corresponding client device's search result. In other embodiments, the triggering of a status request from a client device is prompted by the search interface of the searching device.

In one embodiment, the status information from client devices effect search result ordering. For example, a searching device receives search results from various sources of information including various client devices having a multitude of different statuses or no status at all. In some embodiments, the searching device is configured to account for client device's status within the search results and order the search results based on the accessibility. For yet another example, the searching device receives results ordered to show search results having a status of “greater than 90% battery life” listed before all other status. In alternative embodiments, the searching device is configured to order the search results so that offline or inaccessible client devices are listed at the end of the search results.

In one embodiment, the client device is configured such that certain groups of users, or particular users, receive different status information along with the search results. For example, a client device has a group of contacts that are family only. The client device is configured so that members of the group of family contacts receive status information from the client device indicating that the device is “available.” Non-members of the group of family contacts attempting to interact with the client device are given an “offline” status. In another embodiment, the client device is configured so that status information is privately listed and can only be accessed by designated group members. For yet another example, the client device is configured to provide status information to all listed contacts within an address book. Various combinations of groups and status information can be configured on the client device and are anticipated by the technology described herein.

In an example embodiment, the client device is configured to provide different access levels to the searching devices based on the searching device limitations. Searching device limitations include, for example, hardware or software components for processing the content, bandwidth or network limitations, compatibility of the resolution of content format, other processing or functional limitations or any combination thereof.

In alternative embodiments, client device access levels are configured based on the type of content. Groups are created on the client device with permissions as to what the members of the groups have access to. For example, a client device that has premium content such as films or music and is configured to limit accessibility to the premium content by allowing only a few members to access. The client device is configured to limit accessibility by creating a group of certain members and allow access to the premium content to that group. In one embodiment, groups are created on a client device by entering in a contact name, user identification information, device identification or other forms of identification into a group list. Each group is configured on the client device with certain levels of accessibility such as “no access”, “open access”, “no access to premium content”, “photo access only” or access by any content type, or any combination thereof.

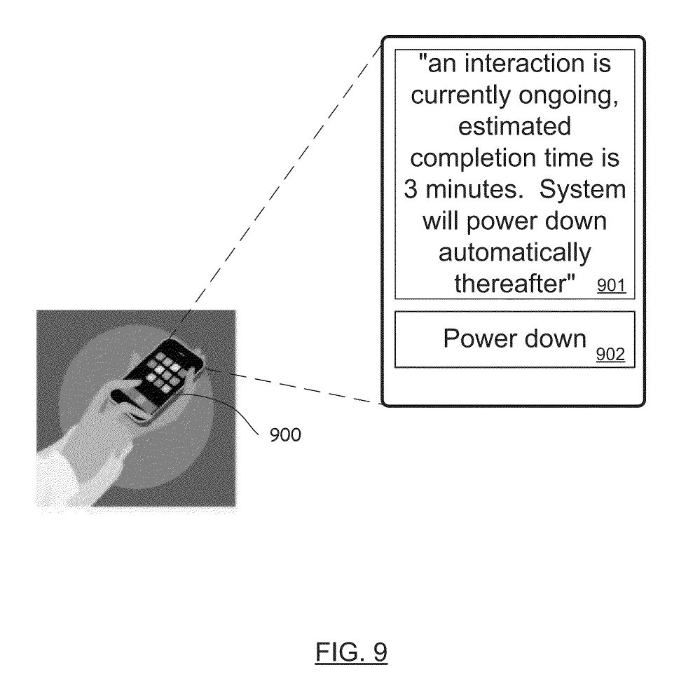

FIG. 9 illustrates a client device embodiment for powering down the device in accordance with the present disclosure. In one embodiment, the client device takes, for example, a minute to fully power up in response to a searching device's access selection. When a download, streaming or service interaction is granted between a searching device and a client device 900 through direct peer to peer interaction, a user is not be able to turn off the underlying client device freely or at least without warning so that the interaction remains uninterrupted. For example, an attempt to turn off a device with a message that states “an interaction is currently ongoing, estimated completion time is 3 minutes. System will power down automatically thereafter” (interaction message 901) prevents premature termination of the interaction between the searching device and the client device. In alternative embodiments, the service interaction between the searching device and the client device is through a search infrastructure proxy.

In one embodiment, an interaction between a searching device and a client device occurs over time. The searching device retrieved search results at an initial time but requested access to the client device selection after, for example, 3 minutes has passed. In order to ensure that the interaction is still possible, a “search results pending” communication (interaction message 901) is provided to the client device as a notification. Other notifications indicative of a pending interaction are considered within scope of the technology described herein. In another embodiment, highlighting an individual result is indicative of a change in status.

In another embodiment, all other client device functionality not needed for maintaining the ongoing interaction between the searching device and the client device is powered down 902 immediately. For example, a direct peer-to-peer connection is operating between a searching device and a client device for downloading a search result such as a video. All other functionality such as internet browsers, camera, applications and other equivalents are discontinued during the download. When the peer-to-peer download is complete, the required service for the download is powered down. In another embodiment, the user of the client device overrides the delayed power down from the peer-to-peer download.

In an embodiment of the technology described herein the wireless connection can communicate in accordance with a wireless network protocol such as Wi-Fi, WiHD, NGMS, IEEE 802.11a, ac, b, g, n, or other 802.11 standard protocol, Bluetooth, Ultra-Wideband (UWB), WIMAX, or other known or future wireless network protocol, a wireless telephony data/voice protocol such as Global System for Mobile Communications (GSM), General Packet Radio Service (GPRS), Enhanced Data Rates for Global Evolution (EDGE), Personal Communication Services (PCS), or other known or future mobile wireless protocol or other wireless communication protocol, either standard or proprietary. Further, the wireless communication path can include separate transmit and receive paths that use separate carrier frequencies and/or separate frequency channels. Alternatively, a single frequency or frequency channel can be used to bi-directionally communicate data to and from the mobile communication device.

Throughout the specification, drawings and claims various terminology is used to describe the one or more embodiments. As may be used herein, the terms “substantially” and “approximately” provides an industry-accepted tolerance for its corresponding term and/or relativity between items. Such an industry-accepted tolerance ranges from less than one percent to fifty percent. Such relativity between items ranges from a difference of a few percent to magnitude differences. As may also be used herein, the terms “smartphone”, “mobile phone” and “cellular phone” are considered equivalent.

As may also be used herein, the terms “processing module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The technology as described herein has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed technology described herein. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed technology described herein. One of average skill in the art will also recognize that the functional building blocks, and other illustrative blocks, modules and components herein, can be implemented as illustrated or by discrete components, application specific integrated circuits, processors executing appropriate software and the like or any combination thereof.

The technology as described herein may have also been described, at least in part, in terms of one or more embodiments. An embodiment of the technology as described herein is used herein to illustrate an aspect thereof, a feature thereof, a concept thereof, and/or an example thereof. A physical embodiment of an apparatus, an article of manufacture, a machine, and/or of a process that embodies the technology described herein may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While particular combinations of various functions and features of the technology as described herein have been expressly described herein, other combinations of these features and functions are likewise possible. The technology as described herein is not limited by the particular examples disclosed herein and expressly incorporates these other combinations.

1. A method performed by a search service, the method comprising:
receiving a search query from a searching device;
retrieving at least one search result from a search infrastructure based on the received search query and associated with client device hosted content;
identifying status information of the client device hosting the content; and
providing the at least one retrieved search result to the searching device with the identified status information.

2. The method of claim 1, further comprising retrieving the identified status information of the client device from a client device registry.

3. The method of claim 1, wherein the identified status information is any of: device specific, content specific and service specific.

4. The method of claim 1, further comprising filtering the at least one search result based on the identified status information of the client device hosting the content, the filtering based on modes of operation or availability of the client device.

5. The method of claim 1, further comprising preventing premature termination of access to the client device hosted content.

6. The method of claim 1, wherein the identified status information includes one or more of: client device identification, client device type, availability, battery charging parameters, client device preferences, and predicted period of availability.

7. The method of claim 1, further comprising the search service requesting an updated status of the identified status information.

8. The method of claim 1, wherein the search service requesting updated status of the identified status information is performed on a periodic basis.

9. A method performed by a client device, the method comprising:
hosting search infrastructure accessible content;
uploading to the search infrastructure at least a portion of the stored content;
updating a status of the client device; and
communicating the updated status to the search infrastructure.

10. The method of claim 9, further comprising communicating the updated status to a client device registry.

11. The method of claim 10, wherein the communicating step comprises communicating the updated status to the client device registry which subsequently communicates the updated status to the search infrastructure.

12. The method of claim 10, wherein the client device registry is updated by any of: periodic updates, non-periodic updates, client device status change, pushed updates, pulled updates, requests from the search infrastructure, requests from the searching device and communication infrastructure limitations.

13. The method of claim 9, receiving from a device remote from the client device a request to change the status of the client device.

14. The method of claim 9, further comprising receiving a request preventing premature termination of access to the hosted search infrastructure accessible content.

15. The method of claim 9, further comprising receiving an interactive notification not to terminate access to the hosted search infrastructure accessible content.

16. A system to support a search service, the system comprising:
one or more crawler modules to crawl, parse and index remotely located web page and client device hosted search accessible content;
a database structure to store indexed content from the one or more crawler modules;
a search engine to receive search requests from one or more search requestors and search the database structure to produce search results;
a client device registry retaining status information of the client devices hosting search accessible content; and
the search service returning to the one or more search requesters the produced search results including the status information of a device hosting search accessible content included in the produced search results.

17. The system of claim 16, further comprising the client device registry updated by any of: periodic updates, non-periodic updates, client device status change, pushed updates, pulled updates, requests from the search service, requests from a search requesting device and communication infrastructure limitations.

18. The system of claim 16, wherein the identified status information is device specific, content specific, service specific or any combination thereof.

19. The system of claim 16, further comprising a cache memory to temporarily store the client device hosted search accessible content.

20. The system of claim 16, further comprising processing an activator to request a change in the status of the device hosting search accessible content included in the produced search results.
